(19) United States
(12) Patent Application Publication
(10) Pub. No.: US 2017/0002785 A1
(43) Pub. Date: Jan. 5, 2017

(54) VEHICLE IGNITION SYSTEM DETECTION DEVICE

(71) Applicant: CHUNG-YI HUANG, TW (TW)

(72) Inventor: CHUNG-YI HUANG, TW (TW)

(21) Appl. No.: 15/165,699

(22) Filed: May 26, 2016

(30) Foreign Application Priority Data
Jun. 30, 2015 (TW) 104210534

(51) Int. Cl. F02P 17/02

(52) U.S. Cl. CPC F02P 17/02

(57) ABSTRACT

A vehicle ignition system detection device is cooperated with a diagnostic unit and includes a detection unit. The detection unit includes multiple ignition system output holes and multiple detection cables. Each of the detection cables has a plug end and a patch end. Each of the plug ends is inserted in the ignition system output hole corresponding thereto, and each of the patch ends is connected to the coil corresponding thereto. The electro-magnetic detection signals between the patch ends and the coils are sent to the display screen of the diagnostic unit so that the maintainers are acknowledged the conditions of the ignition system.

### BACKGROUND OF THE INVENTION

1. Fields of the invention

The present invention relates to a detection device, and more particularly, to a vehicle ignition system detection device.

2. Descriptions of Related Art

The conventional ignition system for vehicles generally comprises battery, a main switch connected to the battery, a coil connected to the main switch, a spark plug connected to the coil, and a detection device for detecting the revolution of the engine and generating corresponding signals. The detection device detects the revolutions of the engine, and controls the ignition time of the coil such that the spark plug generates sparks in the engine to ignite the fuel to generate force to move the vehicle.

The ignition system is an important system for the vehicle, so that the objective of the present invention is to let the maintainers to quickly acknowledge the problems of the ignition system.

The present invention intends to provide a vehicle ignition system detection device to eliminate the shortcomings mentioned above.

### SUMMARY OF THE INVENTION

The present invention relates to a vehicle ignition system detection device installed between the coils, and comprises a diagnostic unit having a first IC circuit board located therein. At least one switch, a display screen and a first I/O connection port are installed on the outside of the diagnostic unit. A detection unit has a room defined therein in which at least one second IC circuit board is received. The detection unit has a power input hole, a detection unit output hole and multiple ignition system output holes defined in the outside thereof. The power input hole, the detection unit output hole and the ignition system output holes are electrically connected with the at least one second IC circuit board. A power connection cable unit has a first end and a second end, wherein the first end is inserted in the power input hole, and the second end is connected to a battery. A connection cable unit has a first end and a second end. The first end of the connection cable unit is inserted in the detection unit output hole, and the second end of the connection cable unit has a plug which is inserted in the first I/O connection port.

Multiple detection cables each have a plug end and a patch end. The number of the detection cables is the same as that of the ignition system output holes. Each of the plug ends is inserted in the ignition system output hole corresponding thereto, and each of the patch ends is connected to the coil corresponding thereto. The electro-magnetic detection signals between the patch ends and the coils are sent to the display screen of the diagnostic unit to be judged by the maintainers.

Preferably, there are eight ignition system output holes and eight detection cables which are connected to the eight ignition system output holes.

Preferably, the present invention further comprises a second connection cable unit and a plug which is inserted into a second I/O connection port on the outside of the diagnostic unit. The first and second I/O connection ports are electrically connected to the second IC circuit board. The plug of the second connection cable unit is connected to vehicle control computer. The second I/O connection port is connected to an operation device via the second connection cable unit. The operation device is connected with a storage device by wire or wireless to read information in the storage device.

Preferably, the diagnostic unit has a positive connection port and a negative connection port defined in the outside thereof. A detection member is electrically connected to the positive and negative connection ports. The first IC circuit board has a detection unit, an A/D converter unit, a processing unit and a display unit. The detection unit is electrically connected to the connection ports and receives analog signals input the connection ports. The A/D converter unit is electrically connected to the detection unit and receives the analog signals and transfers the analog signals into digital signals. The processing unit receives the digital signals from the A/D converter unit and processes and compare the digital signals and creates a result which is sent to the display unit which shows the result in forms of digits or patterns on the display screen of the diagnostic unit.

The advantages of the present invention are that the vehicle ignition system detection device of the present invention is able to detect the mechanical problems, malfunctions of the system, and the correction of the factors of the ignition system. The maintainers simply connect the patch ends to the coils to get the electro-magnetic detection signals between the patch ends and the coils, this allows the maintainers to quickly figure out the problems of the ignition system.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view of the vehicle ignition system detection device of the present invention;

FIG. 2 is an end view of the vehicle ignition system detection device of the present invention;

FIG. 3 is a front view of the vehicle ignition system detection device of the present invention;

FIG. 4 shows the block diagram of the vehicle ignition system detection device of the present invention;

FIG. 5 shows the vehicle ignition system detection device of the present invention and the power connection cable unit, the connection cable unit and the detection cables;

FIG. 6 shows the connection between the diagnostic unit of the vehicle ignition system detection device of the present invention and the battery and the detection device.

### DETAILED DESCRIPTION OF THE PREFERRED EMBODIMENT

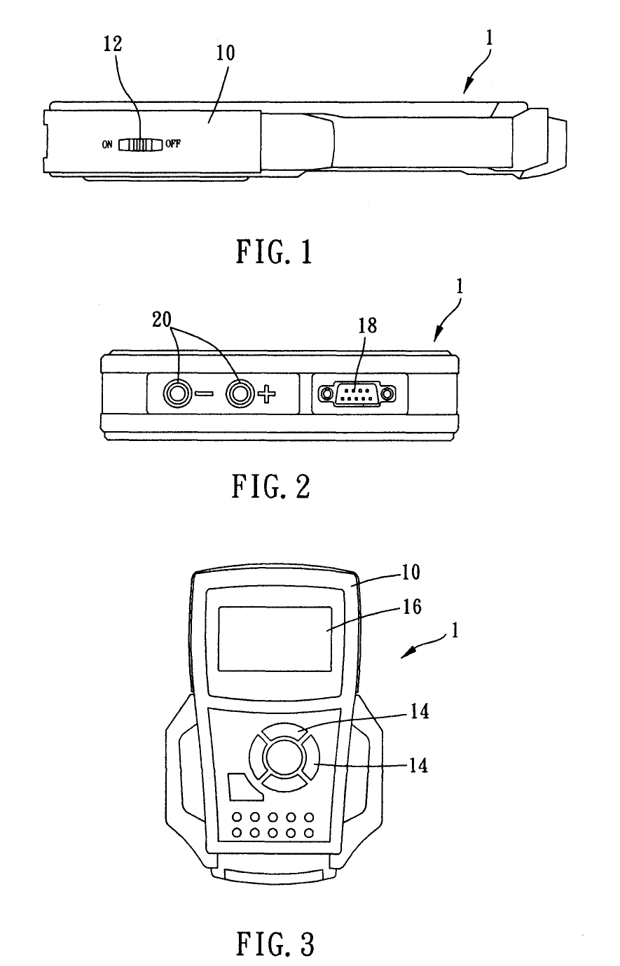

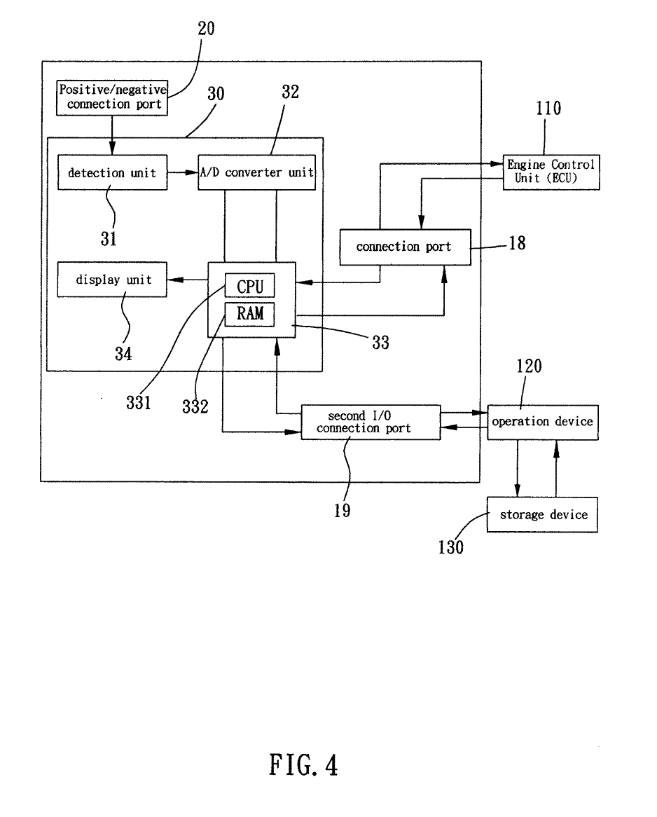

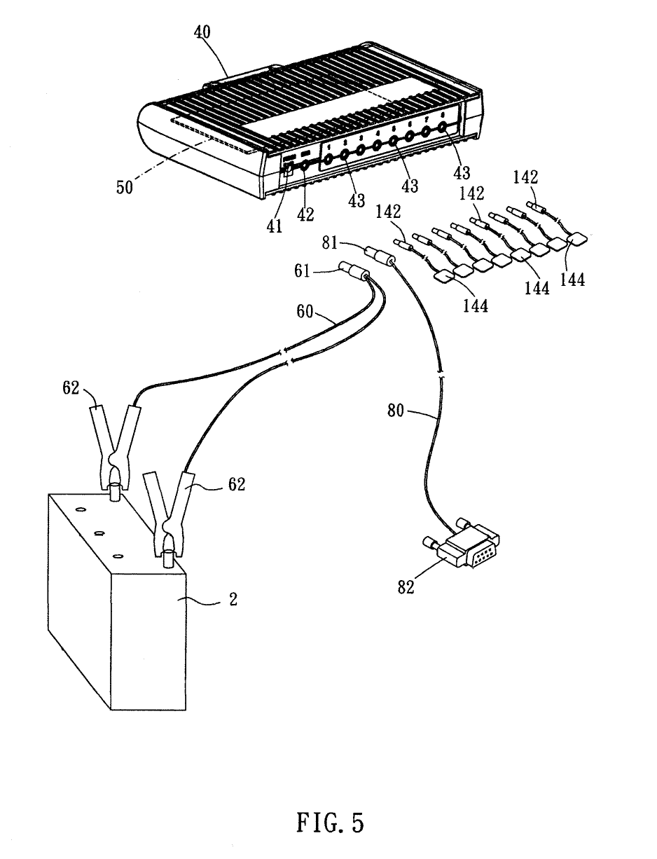

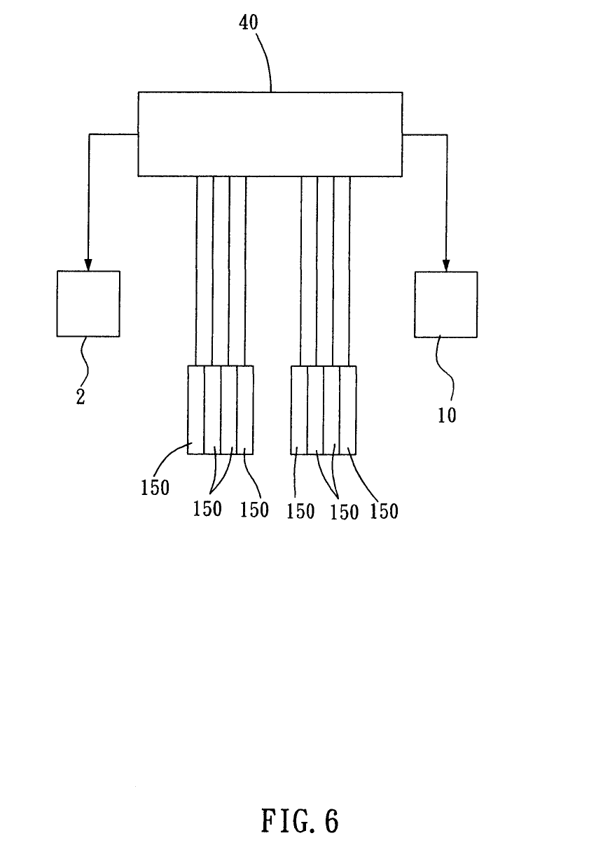

Referring to FIGS. 1 to 6, the vehicle ignition system detection device 1 is installed between the coils 150, and is powered by a battery 2 of the vehicle. The vehicle ignition system detection device 1 can also be connected with the Engine Control Unit (ECU) of the vehicle.

The vehicle ignition system detection device 1 of the present invention comprises a diagnostic unit 10 which is composed of two parts which are connected to each other so as to define a room therein, and a first IC circuit board 30 is located in the room of the diagnostic unit 10. A switch 12 is located on the outside of the diagnostic unit 10 to control the ON/OFF function. Preferably, the diagnostic unit 10 has a function selection portion 14 on the outside thereof so as to switch the detection modes and be cooperated with different detection members. In this embodiment, the function selection portion 14 has a multiple direction button or other similar witch or button. A display screen 16 and a first I/O connection port 18 are installed on the outside of the diagnostic unit 10. The display screen 16 shows the detection signals in the forms of digits or patterns, preferably, the display screen 16 is a Liquid Crystal Display (LCD).

The diagnostic unit 10 further has a positive connection port 20 and a negative connection port 20 defined in the outside thereof. A detection member (not shown) such as a tri-function gauge is electrically connected to the positive and negative connection ports 20. The detection member can be cooperated with the function selection portion 14.

The first IC circuit board 30 has a detection unit 31, an A/D converter unit 32, a processing unit 33 and a display unit 34. The detection unit 31 is electrically connected to the connection ports 20 and receives analog signals input the connection ports 20. The A/D converter unit 32 is electrically connected to the detection unit 31 and receives the analog signals and transfers the analog signals into digital signals. The processing unit 33 has a Central Processing Unit (CPU) 331 and a Random Access Memory (RAM) 332. The processing unit 33 receives the digital signals from the A/D converter unit 32 and processes and compare the digital signals and creates a result which is sent to the display unit 34 which shows the result in forms of digits or patterns on the display screen 16 of the diagnostic unit 10.

A detection unit 40 is composed of two parts which are connected to each other so as to define a room defined therein in which a second IC circuit board 50 is received. The detection unit 40 has a power input hole 41, a detection device output hole 42 and multiple ignition system output holes 43 defined in the outside thereof. The power input hole 41, the detection device output hole 42 and the ignition system output holes 43 are electrically connected with the second IC circuit board 50. Preferably, there are eight ignition system output holes 43 and eight detection cables 140 which are connected to the eight ignition system output holes 43.

A power connection cable unit 60 has a first end 61 and a second end 62, wherein the first end 61 is inserted in the power input hole 41, and the second end 62 has two clamps which are connected to the positive and negative studs of a battery 2.

A connection cable unit 80 has a first end 81 and a second end, wherein the second end is a plug 82. The first end 81 of the connection cable unit 80 is inserted in the detection device output hole 42, and the plug 82 of the second end of the connection cable unit 80 is inserted in the connection stud 21 of the first I/O connection port 18. The plug 82 of the second connection cable unit 80 is connected to ECU 110.

The present invention may also has another second connection cable unit and a plug, the plug is inserted into a second I/O connection port 19 on the outside of the diagnostic unit 10. The first and second I/O connection ports 18, 19 are electrically connected to the second IC circuit board 19. The plug of the second connection cable unit is connected to an operation device 120 via the second I/O connection port 19. The operation device 120 is connected with a storage device 130 by wire or wireless to read information in the storage device 130. Preferably, the second connection cable unit has a USB, and the operation device 120 is a personal computer, a laptop or a planer computer. The storage device 130 is the hard disk in the personal computer, a laptop or a planer computer, and the operation device 120 reads the factors and information in an auto repair garage or the ECU of a vehicle. Preferably, the storage device 130 is a remote servo hard disk in which the factors and information of the vehicles of different makes are stored. When the maintainers use the operation device 120, the factors and information can be obtained by way of wired or wireless such that the maintainers can correct or reset the factors of the ECU of the vehicle by using Applications (APPs) in the laptop or planar computer.

Multiple detection cables 140 each have a plug end 142 and a patch end 144. The number of the detection cables 140 is the same as that of the ignition system output holes 43. In this embodiment, there are eight detection cables 140. Each of the plug ends 142 is inserted in the ignition system output hole 43 corresponding thereto, and each of the patch ends 144 is connected to the coil 150 corresponding thereto. The electro-magnetic detection signals between the patch ends 144 and the coils 150 are sent to the display screen 16 of the diagnostic unit 10. The maintainers judge the digits or patterns on the display screen 16 to determine the correction and setting of the ignition system of the vehicle.

The present invention comprises eight ignition system output holes 43 and eight detection cables 140, this is cooperated with the four-cylinder vehicles. When the number of the cylinders of the vehicle is less than four or more than four, such as V6, V8 or V12 engine, the number of the ignition system input holes can be increased so as to detect the signals of each of the cylinders.

When in use, the path ends 144 are attached to the four coils 150 of each of the cylinders, so as to detect the voltage signals and the ignition signals of each coil 150 by magnetic way. The information of the detected signals is sent to the display screen 16 of the diagnostic unit 10 by the connection cable unit 80. The display screen 16 displays the information in the form of positive and negative waves, so that the users can judge the status of the coils 150, or knows which coil 150 needs to be repaired or replaced.

Alternatively, instead of using the detection cables 140 to get the necessary information, the maintainers can also get the signals of the ignition system from the ECU 110 via the first I/O connection port 18, and then the signals are set to the RAM of the second circuit board 50. The signals are then compared with the pre-set information in the storage device 130, the pre-set information is obtained by way of wired or wireless by using the operation device 120 via the second I/O connection port 19. When there is difference between the received signals and the pre-set information, the maintainers can correct the vehicle ignition system in the ECU 110 via the operation device 120.

The present invention can quickly check the coils 150 by connecting the plug ends 142 of the detection cables 140 to the ignition system output hole 43 corresponding thereto, and connecting the patch ends 144 to the coils 150. The electro-magnetic detection signals between the patch ends 144 and the coils 150 are sent to the display screen 16 of the diagnostic unit 10. The maintainers judge the digits or patterns on the display screen 16 to determine the correction and setting of the ignition system of the vehicle. The vehicle ignition system detection device of the present invention is able to detect the mechanical problems, malfunctions of the ignition system of the ECU, and the correction of the factors of the ignition system within a short period of time.

While we have shown and described the embodiment in accordance with the present invention, it should be clear to those skilled in the art that further embodiments may be made without departing from the scope of the present invention.

What is claimed is:

1. A vehicle ignition system detection device installed between the coils, comprising:
a diagnostic unit having a first IC circuit board located therein, at least one switch, a display screen and a first I/O connection port installed on an outside of the diagnostic unit;
a detection unit having a room defined therein in which at least one second IC circuit board is received, the detection unit having a power input hole, a detection device output hole and multiple ignition system output holes defined in an outside thereof, the power input hole, the detection device output hole and the ignition system output holes electrically connected with the at least one second IC circuit board;
a power connection cable unit having a first end and a second end, the first end of the power connection cable unit inserted in the power input hole, the second end of the power connection cable unit connected to a battery;
a connection cable unit having a first end and a second end, the first end of the connection cable unit inserted in the detection device output hole, the second end of the connection cable unit 80 having a plug which is inserted in the first I/O connection port, and
multiple detection cables each having a plug end and a patch end, a number of the detection cables being the same as that of the ignition system output holes, each of the plug ends inserted in the ignition system output hole corresponding thereto, each of the patch ends connected to the coil corresponding thereto, electro-magnetic detection signals between the patch ends and the coils being sent to the display screen of the diagnostic unit.

2. The vehicle ignition system detection device as claimed in claim 1, wherein there are eight ignition system output holes and eight detection cables which are connected to the eight ignition system output holes.

3. The vehicle ignition system detection device as claimed in claim 1 further comprising a second connection cable unit, the diagnostic unit having a second I/O connection port connected to the outside thereof, the first and second I/O connection ports electrically connected to the second IC circuit board, the second I/O connection port connected to an operation device via the second connection cable unit, the operation device connected with a storage device by wire or wireless to read information in the storage device.

4. The vehicle ignition system detection device as claimed in claim 3, wherein the diagnostic unit has a positive connection port and a negative connection port defined in the outside thereof, a detection member is electrically connected to the positive and negative connection ports, the first IC circuit board has a detection unit, an A/D converter unit, a processing unit and a display unit, the detection unit is electrically connected to the connection ports and receives analog signals input the connection ports, the A/D converter unit is electrically connected to the detection unit and receives the analog signals and transfers the analog signals into digital signals, the processing unit receives the digital signals from the A/D converter unit and processes and compare the digital signals, and creates a result which is sent to the display unit which shows the result in forms of digits or patterns on the display screen of the diagnostic unit.
